(19) United States
(12) Patent Application Publication
(10) Pub. No.: US 2007/0006901 A1
(43) Pub. Date: Jan. 11, 2007

(54) Dishwasher and method of controlling the same

(76) Inventors: In Haeng Cho, Changwon-si (KR); Joung Hun Kim, Changwon-si (KR)

Correspondence Address: Song K. Jung;MCKENNA LONG & ALDRIDGE LLP, 1900 K Street, N.W., Washington, DC, 20006, US

(21) Appl. No.: 11/483,852

(22) Filed: Jul. 11, 2006

(30) Foreign Application Priority Data
Jul. 11, 2005 (KR) 10-2005-0062249

(51) Int. Cl. B08B 7/04; B08B 9/20; B08B 3/00; B08B 3/04; B08B 3/12

(52) U.S. Cl. 134/25.2; 134/56 D; 134/172; 134/103.2; 134/104.2; 134/18; 134/34

(57) ABSTRACT

A dishwasher is provided. The dishwasher includes a tub defining a washing chamber, a lower nozzle formed in the tube to spray washing nozzle, an upper nozzle formed in the tube above the lower nozzle, a key input unit for inputting one of a lower nozzle washing course and a upper nozzle washing course, and a control unit for controlling an operation of the dishwasher according to a washing course inputted through the key input unit. When the upper nozzle washing course is selected through the key input unit, the control unit controls the dishwasher such that the lower nozzle washing course is performed for a predetermined time period.

### BACKGROUND OF THE INVENTION

1. Field of the Invention

The present invention relates to a dishwasher, and more particularly, to a dishwasher that can fully exhaust detergent out of a dispenser by operating a lower nozzle for a predetermined time period when the washing cycle is performed by only an upper nozzle and a method of controlling the dishwasher.

2. Description of the Related Art

Generally, a dishwasher is a machine that washes dishes using high pressure washing water sprayed from a nozzle.

A conventional dishwasher includes a tub and a sump mounted on a bottom surface of the tub to reserve washing water. A dispenser is mounted on an inner surface of a dishwasher door for dispensing detergent into the tub by a predetermined amount.

A washing pump is provided in the sump to direct the washing water to the spraying nozzle so that the washing water can be sprayed through spraying holes formed on the spraying nozzle.

As the sprayed washing water collides with the dishes, the food wastes are removed from the dishes and falls to the bottom of the tub.

The nozzle includes a lower nozzle spraying the washing water upward, an upper nozzle placed at a center of the tub, and a top nozzle mounted near an inner top of the tube to spray the washing water downward.

The washing efficiency of the dishwasher may be determined depending on if the detergent stored in the dispenser is fully exhausted. Therefore, there is a need for means that can fully exhaust the detergent when the door is closed.

Particularly, there is a need to solve a problem that the detergent cannot be fully exhausted from the dispenser when the washing cycle is performed by only the upper nozzle.

### SUMMARY OF THE INVENTION

Accordingly, the present invention is directed to a dishwasher and a method of controlling the dishwasher that substantially obviates one or more problems due to limitations and disadvantages of the related art.

An object of the present invention is to provide a dishwasher that can fully exhaust detergent out of a dispenser by operating a lower nozzle for a predetermined time period when the washing cycle is performed by only an upper nozzle and a method of controlling the dishwasher.

To achieve these objects and other advantages and in accordance with the purpose of the invention, as embodied and broadly described herein, there is provided a dishwasher including: a tub defining a washing chamber; a lower nozzle formed in the tube to spray washing water; an upper nozzle formed in the tube above the lower nozzle; a key input unit for inputting one of a lower nozzle washing course and a upper nozzle washing course; and a control unit for controlling an operation of the dishwasher according to a washing course inputted through the key input unit, wherein, when the upper nozzle washing course is selected through the key input unit, the control unit controls the dishwasher such that the lower nozzle washing course is performed for a predetermined time period.

In another aspect of the present invention, there is provided a method of controlling a dishwasher, including: inputting a washing course; performing a lower nozzle washing course for a predetermined time period when the inputted washing course is an upper nozzle washing course; and performing the upper nozzle washing course after the lower nozzle washing course is performed for the predetermined time period.

According to the present invention, even when the upper nozzle washing course is selected, the detergent can be fully exhausted from the dispenser, thereby improving the washing efficiency.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a dishwasher according to an embodiment of the present invention, in which a door is open;

FIG. 2 is a partial perspective view of a detergent dispenser of the dishwasher of FIG. 1;

FIG. 3 is a sectional view of the dishwasher of FIG. 1;

FIGS. 4 and 5 are views illustrating respectively an upper nozzle washing and a lower nozzle washing of the dishwasher of FIG. 1;

FIG. 6 is a block diagram of the dishwasher according to the embodiment of the present invention; and

FIG. 7 is a flowchart illustrating a method of controlling a dishwasher according to an embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

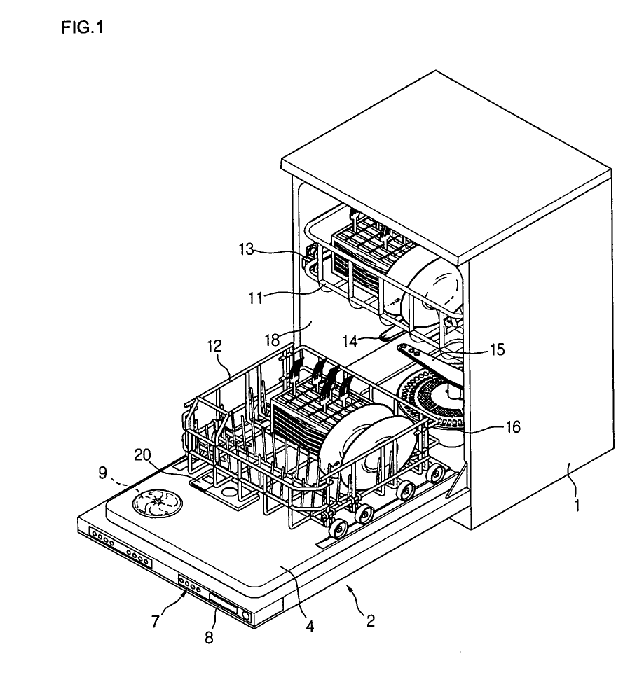

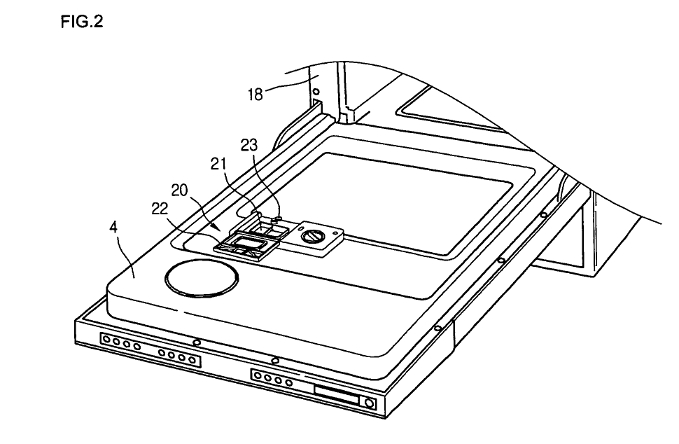

FIG. 1 is a perspective view of a dishwasher according to an embodiment of the present invention, in which a door is open and FIG. 2 is a partial perspective view of a detergent dispenser of the dishwasher of FIG. 1.

Referring to FIGS. 1 and 2, a dishwasher includes a case 1 defining an appearance of the dishwasher 10 and having an opened front portion, a door 2 installed on the opened front portion of the case 1, a control panel 3 formed on an upper portion of the door 2 to display and control the operation the dishwasher.

The dishwasher further includes a tub 18 defining a washing chamber, a sump 16 mounted on a bottom-center of the tub 18 and reserving washing water therein, upper and lower nozzles 14 and 15 for spraying the washing water reserved in the sump.

The dishwasher further includes upper and lower racks 11 and 12 for receiving the dishes and rails 13 mounted on walls of the tub 18 to guide the movement the racks 11 and 12.

The control panel 3 includes a key input unit 7 for setting the washing mode and a display unit 8 for displaying the operation of the dishwasher. The user can select the upper nozzle washing course and a lower nozzle washing course through the key input unit.

In this case, when the dishes are loaded in only the upper rack, the user select the upper nozzle washing course so that only the upper nozzle operates, thereby saving the washing water and reducing the power consumption.

That is, in the upper nozzle washing course, only the upper nozzle 14 is operated and, in the lower nozzle washing course, only the lower nozzle 15 is operated. The control method of the upper nozzle washing course of the dishwasher will be described later.

A door liner 4 is mounted on an inner side of the door 2. The door liner 4 is provided with a groove for moving the lower rack 12 frontward and an outlet 9 for exhausting vapor out of the tub 18.

As shown in FIG. 2, a detergent dispenser for storing detergent is formed on a side of the door liner 4. The dispenser 20 includes a detergent storing portion 21 defining a space for storing the detergent, a cover 22 for opening/closing the detergent storing portion 21, a locker 23 for controlling the opening/closing of the cover 22.

The operation of the dispenser 20 will now be described. The user inputs the detergent in the dispenser with the door opened.

After the door is closed, the operation button of the dishwasher is pushed. Then, the locker 23 is controlled to open the cover 22. Then, the detergent stored in the detergent storing portion flows downward along the door liner 4 to the bottom surface of the tub 18.

The detergent on the bottom surface of the tub 18 is mixed with the washing water reserved in the sump 16 and sprayed through the upper and lower nozzles 14 and 15.

The dispenser 20 is formed on the side of the door liner 4 and disposed between the upper and lower racks 11 and 12.

Particularly, the dispenser 20 is disposed at a same plane as the upper nozzle 14. Therefore, less washing water sprayed through the upper nozzle 14 collides with the dispenser 20 as compared with that sprayed through the lower nozzle 14.

That is, as the cover 22 is open, the detergent falls downward. However, a part of the detergent is still remained in the detergent storing portion 21.

Therefore, when the washing water is sprayed toward the dispenser 20 in the washing cycle, the washing water collides with the residual detergent in the detergent storing portion 21 and thus the detergent fully falls into the tub.

Considering the washing water is sprayed upward through the upper nozzle 14, there is no proper distance between the dispenser 20 and the upper nozzle 14 and thus the washing water sprayed through the upper nozzle 14 cannot collide with the dispenser 20.

Meanwhile, the part of the washing water sprayed through the lower nozzle 15 collides with the dispenser 20 and thus the residual detergent in the dispenser 20 fully falls into the tube.

Therefore, when the upper nozzle washing course is performed, the lower nozzle 15 is operated for a predetermined time period in advance even when the cover 21 of the dispenser 20 is open.

This will now be described in more detail.

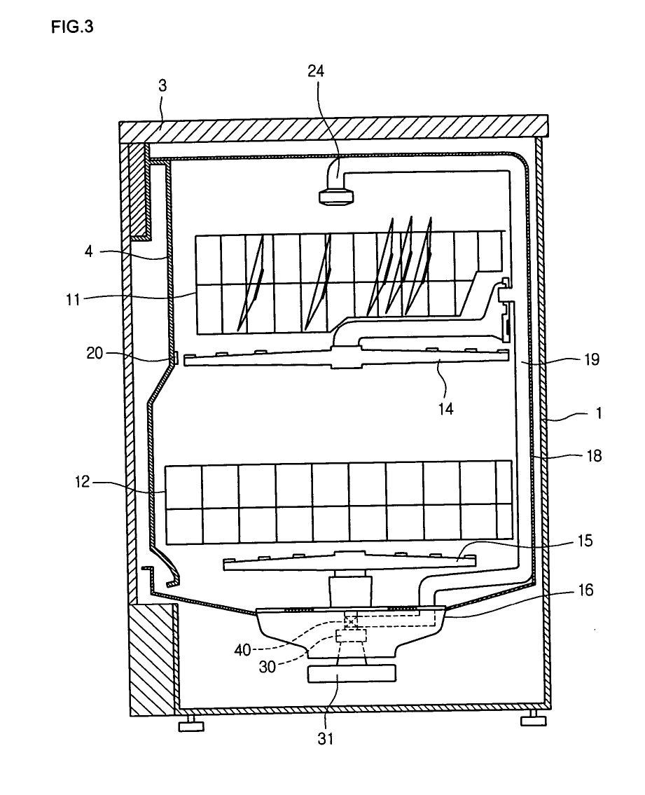

FIG. 3 is a sectional view of the dishwasher of FIG. 1 and FIGS. 4 and 5 are views illustrating respectively an upper nozzle washing and a lower nozzle washing of the dishwasher of FIG. 1.

In FIGS. 3 through 5, the same parts as those of FIGS. 1 and 2 will be assigned with like numbers.

Referring first to FIG. 3, the dishwasher includes the sump 16 for reserving the washing water, the tub 18 for receiving the racks 11 and 12 for receiving, the lower nozzle 15 formed above the sump 16, the lower nozzle 14 formed under the upper rack 11, and the top nozzle 24 formed above the upper rack 11.

The dishwasher further includes a washing motor 31 for pumping the washing water out of the sump 16 and directing the washing water to the upper or lower nozzle 14 or 15 and a washing pump 30 operated by the washing motor 31.

A vario valve 40 for providing a flow path of the washing water pumped by the washing pump 30 is provided in the sump 16 to allow the washing water to be directed one of the upper and lower nozzles 15 and 15.

As the vario valve 40 rotates, the flow path along which the washing water flow is formed. The rotation of the vario valve is done by a rotational motor.

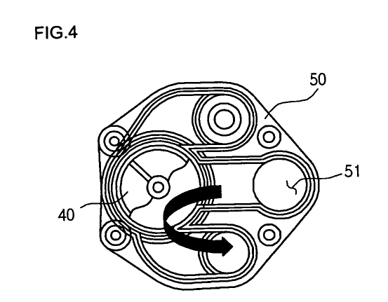

FIG. 4 shows a case where the washing water flows toward the lower nozzle 15 along the flow path formed by the vario valve 40. The vario valve 40 is disposed in a passage guide 50 formed in the sump 16.

The passage guide 50 is provided with a hole 51 through which the washing water pumped out by the washing pump 30 and the washing motor 31 is introduced. The washing water introduced through the hole 51 flows along the flow path provided by the vario valve 40.

When the vario valve 40 is positioned as shown in FIG. 4, the washing water introduced through the hole 51 flows in a direction indicated by arrow and moves to the lower nozzle 15.

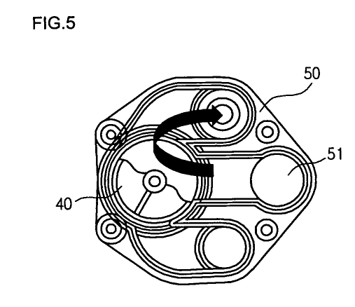

FIG. 5 shows a case where the flow path is changed by the rotation of the vario valve by the rotational motor. In this case, since the opening is changed, the washing water introduced through the hole 51 flows in a direction indicated by arrow of FIG. 5 to the water guide 19.

The washing water directed to the water guide 19 is sprayed through the upper nozzle 14 to perform the upper nozzle washing course.

Therefore, the washing water flows toward one of the upper and lower nozzles 14 and 15 and sprayed through one of them to perform the upper or lower washing course.

However, when the upper washing course is selected through the key input unit 7, the lower nozzle washing course is performed by the lower nozzle 15 for a predetermined time period before the upper nozzle washing cycle starts. This is to fully exhaust the detergent out of the dispenser 20.

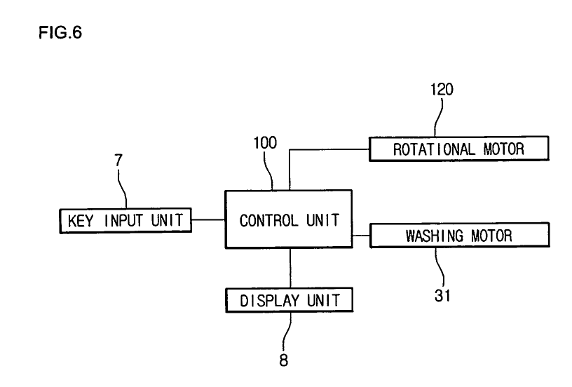

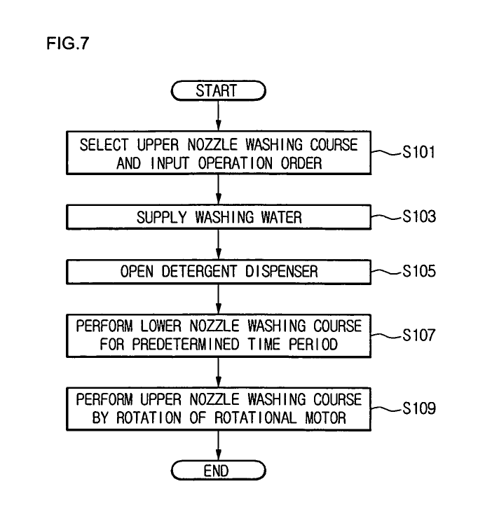

FIG. 6 is a block diagram of the dishwasher according to the embodiment of the present invention and FIG. 7 is a flowchart illustrating a method of controlling a dishwasher according to an embodiment of the present invention.

Referring to FIGS. 6 and 7, the dishwasher includes the key input unit 7 through which the user can set the upper nozzle washing course, a control unit 100 for controlling the operation of the dishwasher in response to the order inputted through the key input unit 7, the rotational motor 120 rotating the vario valve 40 according to a control signal from the control unit 100, and the washing motor 31 for pumping the washing water out of the sump 16.

First, when the upper nozzle washing course is set through the key input unit 7 and the operation order is input (S101), the washing water is supplied to the sump (S103).

Then, the control unit 100 controls the lower nozzle 15 such that the washing water is sprayed through the lower nozzle for a predetermined time period before the washing water is sprayed through the upper nozzle 14.

That is, in the upper nozzle washing course selected by the user, the control unit 100 releases the locker 23 to open the cover 21 of the dispenser (S105) At this point, a part of the detergent stored in the dispenser 20 falls downward.

Next, the control unit 100 controls the rotational motor 120 such that the flow path for directing the washing water from the sump to the lower nozzle 15 by the vario valve 40. Therefore, the washing water reserved in the sump 16 is sprayed through the lower nozzle 15 for the predetermined time period (S107).

Therefore, the residual detergent in the dispenser 20 is fully exhausted by the washing water sprayed through the lower nozzle 15.

While the lower nozzle washing course is performed for the predetermined time period, the display unit may display a message letting the user know this.

In addition, the control unit 100 outputs the current washing course (upper or lower nozzle washing course) performed by the flow path formed by the operation of the rotational motor through the display unit 8.

In the upper nozzle washing course, after the washing water is sprayed through the lower nozzle 15 for he predetermined time period, the control unit 100 controls the rotational motor 120 to rotate the vario valve 40 such that the flow path of the washing motor is changed and directed to the water guide 10 by the vario valve 40.

Therefore, as the vario valve 40 rotates by the operation of the rotational motor 120, a flow path is formed as shown in FIG. 5. Thus, the washing water is directed to the water guide 19 and sprayed through the upper nozzle 14 (S109) to perform the upper nozzle washing course.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a tub defining a washing chamber;
a lower nozzle formed in the tube to spray washing water;
an upper nozzle formed in the tube above the lower nozzle;
a key input unit for inputting one of a lower nozzle washing course and a upper nozzle washing course; and
a control unit for controlling an operation of the dishwasher according to a washing course inputted through the key input unit,
wherein, when the upper nozzle washing course is selected through the key input unit, the control unit controls the dishwasher such that the lower nozzle washing course is performed for a predetermined time period.

2. The dishwasher according to claim 1, further comprising a sump provided on a bottom of the tube to reserve the washing water and a vario valve for forming a flow path along which the washing water in the sump flows, wherein the control unit controls the dishwasher such that the flow path is directed to the lower nozzle for the predetermined time period.

3. The dishwasher according to claim 1, further comprising a dispenser mounted on a door for opening and closing the washing chamber, wherein the detergent is fully exhausted out of the dispenser by the lower nozzle washing course during the predetermined time periode.

4. The dishwasher according to claim optical recording media cartridge according to claim 1, wherein the control unit displays an message letting a user to know that the lower nozzle washing course is performed for the predetermined time.

5. The dishwasher according to claim 1, wherein, after the lower nozzle washing course is finished, the control unit controls the dishwasher such that the upper nozzle washing course is performed.

6. A dishwasher comprising:
a washing motor for pumping washing water out of a sump;
a lower nozzle for performing a lower nozzle washing course by spraying the washing water;
an upper nozzle for performing an upper nozzle washing course by spraying the washing water;
a vario valve for forming a flow path of the washing water to one of the upper and lower nozzles;
a rotational motor for rotating the vario valve; and
a control unit for controlling the rotational motor,
wherein, when the upper nozzle washing course is selected, the control unit controls the dishwasher such that the lower nozzle washing course is performed for a predetermined time period before the upper nozzle washing course is performed.

7. The dishwasher according to claim 6, wherein, when the upper nozzle washing course is selected, the control unit controls the rotational motor such that the rotational motor rotates the vario valve to direct the washing water from the sump to the lower nozzle for the predetermined time period.

8. The dishwasher according to claim 6, further comprising a key input unit through which a user selects one of the upper and lower nozzle washing courses.

9. The dishwasher according to claim 6, wherein, after the lower nozzle washing course is finished, the control unit operates the upper nozzle by operating the rotational motor.

10. A dishwasher comprising:
lower and upper nozzles disposed in the tub; and
a key input unit for inputting an upper nozzle washing course where only the upper nozzle is operated; and
a control unit controlling the dishwasher such that, when the upper nozzle washing course is inputted through the key input unit, the upper nozzle is operated after the lower nozzle is operated for a predetermined time period.

11. A method of controlling a dishwasher, comprising:
inputting a washing course;
performing a lower nozzle washing course for a predetermined time period when the inputted washing course is an upper nozzle washing course; and
performing the upper nozzle washing course after the lower nozzle washing course is performed for the predetermined time period.

12. The method according to claim 11, wherein, while the lower nozzle washing course is performed, a display unit displays a message letting the user know that the lower nozzle washing course is being performed.

13. A method of controlling a dishwasher having upper and lower nozzles disposed in tub, the method comprising:
inputting an upper nozzle washing course where the upper nozzle is operated through a key input unit; and
performing a lower nozzle washing course where the lower nozzle is operated for a predetermined time period before the upper nozzle washing course is performed.

14. The method according to claim 13, wherein the upper and lower nozzle washing courses are selected by rotating a vario valve; and
the vario valve is controlled by a control unit such that a flow path is directed to the lower nozzle for the predetermined time period when the upper nozzle washing course is inputted through the key input unit.
